(19) United States
(12) Patent Application Publication
(10) Pub. No.: US 2007/0230067 A1
(43) Pub. Date: Oct. 4, 2007

(54) MAGNETORESISTANCE EFFECT DEVICE, MAGNETIC HEAD, MAGNETIC RECORDING SYSTEM, AND MAGNETIC RANDOM ACCESS MEMORY

(75) Inventors: Arata Jogo, Kawasaki (JP); Yutaka Shimizu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/465,558

(22) Filed: Aug. 18, 2006

(30) Foreign Application Priority Data
Mar. 30, 2006 (JP) 2006-093668

(51) Int. Cl. G11B 5/127; G11B 5/33

(52) U.S. Cl. 360/324.1; 360/324.11

(57) ABSTRACT

A CPP type magnetoresistance effect device having a synthetic ferri-pinned spin valve structure including a buffer layer, pinned ferromagnetic layer, nonmagnetic metal intermediate layer, and free ferromagnetic layer and having a free ferromagnetic layer made a specific composition of CoFeAl or CoMnAl, the buffer layer comprising an amorphous metal bottom layer and a nonmagnetic metal top layer. This magnetoresistance effect device increases the output ΔRA, reduces the coercivity Hc and the amount of shift Hin from a zero magnetic field to increase the sensitivity, and increases the magnetic field Hua of the resistance half point to increase the pin stability. A magnetic head, magnetic recording system, and magnetic random access memory using this magnetoresistance effect device are also disclosed.

### BACKGROUND OF THE INVENTION

1. Field of the Invention

The present invention relates to a magnetoresistance effect device used for a read head reproducing magnetic information in a magnetic recording system such as a hard disk drive, a magnetic head provided with the read head, a magnetic recording system provided with the magnetic head, and a magnetic random access memory using a magnetoresistance effect device, more particularly relates to a current-perpendicular-to-plane type (CPP) magnetoresistance effect device in which current flows in the stacking direction of the component layers of the magnetoresistance effect device.

2. Description of the Related Art

A magnetic reproduction head used in a hard disk drive reads magnetically recorded information by utilizing the fact that the electrical resistance changes in response to the direction of the magnetic field leaking from the disk, that is, the magnetoresistance effect.

FIG. 1 shows the layer configuration of a magnetoresistance effect device generally used as a magnetic reproduction head (for example, Japanese Patent Publication (A) No. 2005-191312, Japanese Patent Publication (A) No. 11-126315, etc.) This magnetoresistance effect device 10 has a structure called a “synthetic ferri-pinned type spin valve film” which is comprised, from the bottom, of a buffer layer 11, antiferromagnetic layer 12, first pinned ferromagnetic layer 13, nonmagnetic coupling layer 14, second pinned ferromagnetic layer 15, nonmagnetic intermediate layer 16, free ferromagnetic layer 17, and cap layer 18. Here, the part P comprised of the first pinned ferromagnetic layer 13/nonmagnetic coupling layer 14/second pinned ferromagnetic layer 15 is called the “synthetic ferri-pinned structure”. The antiferromagnetic coupling through the nonmagnetic coupling layer 14 pins the direction of magnetization of the first pinned ferromagnetic layer 13 and the direction of magnetization of the second pinned ferromagnetic layer 15 to be opposite to each other resulting in a smaller total magnetic moment. Due to this, the demagnetization field of the synthetic ferri-pinned layer P is suppressed and the anisotropy field generated from the exchange coupling with the antiferromagnetic layer 12 is increased as an effect. After this synthetic ferri-pinned structure P (directly, after the second pinned ferromagnetic layer 15) is placed a nonmagnetic intermediate layer 16 and then a free ferromagnetic layer 17. This free ferromagnetic layer 17 easily changes in direction of magnetization in accordance with the direction of the magnetic field leaking from the recording medium. The synthetic ferri-pinned type spin valve film 10 changes in electrical resistance along with the change of the relative angle of the direction of magnetization of the pinned ferromagnetic layer (synthetic ferri-pinned layer P) and the direction of magnetization of the free ferromagnetic layer 17. This magnetoresistance effect is utilized to read the magnetic signal from the recording medium.

At the present time, most read heads of hard disk drives use current-in-plane (CIP) structures where the current for reading the resistance change flows in the film surface direction of the laminated film forming the spin valve structure. On the other hand, along with the increase in capacity of future hard disk drives, the recording area per bit is decreasing and the core widths of the devices are becoming narrower. In view of this situation, a structure where the sense current flows perpendicular to the film surface, i.e., the CPP structure, has been proposed. Small amounts of such heads are already been produced. Such CPP structure spin valve films increase in output along with the smaller core width of the devices and in principle are suited to increased density.

The output of a CPP type spin valve structure is determined by the magnetoresistance change (ΔRA) per unit area of the device. To increase this magnetoresistance change, it is necessary to use a material having spin dependent scattering and a high specific resistance for the free ferromagnetic layer and the pinned ferromagnetic layer in the synthetic ferri pinned structure generating the magnetoresistance effect, The assignee has proposed as this high specific resistance material CoFeAl and CoMnAl limited in ranges of composition in Japanese Patent Application No. 2005-244507 and Japanese Patent Application No. 2005-346065. The present invention also uses these compositions.

However, for use for a read head, a magnetoresistance effect device is required to exhibit not only a magnetoresistance change ΔRA but also the following characteristics:

FIG. 2 schematically shows the change in the resistance of a magnetoresistance effect device when running a sense current through the device to change the external magnetic field.

As shown by the curve X in the figure, the resistance must change with a good sensitivity with respect to the change in the signal magnetic field (external magnetic field) from the recording medium. For this purpose, the coercivity Hc must be made smaller. Hc≦5 Oe is preferable.

Further, for quick change when the direction of the magnetic field from the recording medium changes, the amount of shift Hin from a zero external magnetic field must be made smaller as well. Hin≦20 Oe is preferable.

Further, to prevent the external magnetic field from causing the high resistance state to invert, the pin stability of the synthetic ferri pinned structure is important. As a measure for this, the magnetic field Hua of the point where the resistance falls to half has to be made larger. Hua≧1400 Oe is preferable.

By using the high specific resistance material proposed by the assignee for the free ferromagnetic layer and pinned ferromagnetic layer, a higher magnetoresistance change ΔRA than the past is obtained. However, for practical application as a read head, it is necessary to further increase the magnetoresistance change ΔRA and simultaneously reduce the coercivity Hc.

If using a conventional buffer layer NiCr, when using a high specific resistance film for the magnetic layer of the magnetoresistance effect film, the coercivity Hc tends to become larger due to the crystal structure of the NiFe layer of the bottom electrode. Further, if using Ru or Cu or another nonmagnetic metal as the buffer layer, even if the coercivity Hc falls, simultaneously the amount of shift Hin from the zero magnetic field becomes extremely great and even if the direction of the external magnetic field changes, quick response no longer becomes possible.

In addition, along with the increase in recording density, the read gap, that is, the thickness between the top electrode and bottom electrode, must be made thinner. The buffer layer provided on the bottom electrode must therefore also be made thinner.

### SUMMARY OF THE INVENTION

An object of the present invention is to provide a magnetoresistance effect device increasing the magnetoresistance effect change ΔRA, that is, the output, reducing the coercivity Hc and the amount of shift Hin from a zero magnetic field to increase the sensitivity, and increasing the magnetic field Hua of the resistance half point to increase the pin stability.

Another object of the present invention is to provide a magnetic head, a magnetic recording system, and a magnetic random access memory using the magnetoresistance effect device.

To achieve the first object, according to the present invention, there is provided a CPP type magnetoresistance effect device having a synthetic ferri-pinned spin valve structure including a buffer layer at a bottommost layer, a pinned ferromagnetic layer above that, a nonmagnetic metal intermediate layer, and a free ferromagnetic layer, wherein the free ferromagnetic layer is comprised of one of the following (1) and (2):

(1) a composition in the region of a CoFeAl ternary system composition diagram obtained by connecting a point A, point B, point C, point D, point E, point F, and point A by straight lines in that order for a point A (55,10,35), point B (50,15,35), point C (50,20,30), point D (55,25,20), point E (60,25,15), and point F (70,15,15) when expressing the coordinates of compositions as (Co content, Fe content, Al content [unit of each content being atm %]) and

(2) a composition in the region of a CoMnAl ternary system composition diagram obtained by connecting a point A, point B, point C, point D, point E, point F, and point A by straight lines in that order for a point A (44,23,33), point B (48,25,27), point C (60,20,20), point D (65,15,20), point E (65,10,25), and point F (60,10,30) when expressing the coordinates of the compositions as (Co content, Mn content, Al content [unit of each content being atm %]),

the buffer layer being comprised of a bottom layer of an amorphous metal buffer layer and a top layer of a nonmagnetic metal buffer layer.

The present invention uses the compositions proposed by the assignee in the above prior applications for the free ferromagnetic layer so as to realize a large ΔRA and makes the buffer layer a two-layer structure comprised of a bottom layer of an amorphous metal and a top layer of a nonmagnetic metal so as to reduce both the Hc and Hin and increase the Hua.

That is, the present invention is characterized in the point of making the buffer layer a two-layer structure of an amorphous metal buffer layer/nonmagnetic metal buffer layer instead of the conventional NiCr, NiCrCu, Ta/NiFe, or other crystalline layer.

As explained above, if using the conventional buffer layer NiCr, when using a high specific resistance film for the magnetic layer of the magnetoresistance effect film, the crystal structure of the NiFe layer of the bottom electrode tends to cause the coercivity Hc to become larger. Further, when using a Ru or Cu or other nonmagnetic metal as the buffer layer, even if the coercivity Hc drops too much, simultaneously the shift Hin from the zero magnetic field also becomes extremely great and there is the problem that even if the external magnetic field changes in orientation, a quick reaction is no longer possible.

As opposed to this, the present invention first forms an amorphous metal over the NiFe of the bottom electrode so as to block the effects of the crystal structure of the NiFe of the bottom electrode, then forms a film of a nonmagnetic metal improving the crystallinity of the spin valve film so as to raise the output ΔRA and simultaneously reduce the coercivity Hc and the amount of shift Hin from a zero magnetic field to raise the sensitivity and, simultaneously, improve the pin stability Hua.

### BRIEF DESCRIPTION OF THE DRAWINGS

These and other objects and features of the present invention will become clearer from the following description of the preferred embodiments given with reference to the attached drawings, wherein:

FIG. 1 is a cross-sectional view showing the layer configuration of a magnetoresistance effect device generally used as a conventional magnetic read head;

FIG. 2 is a graph schematically showing the change in resistance of a magnetoresistance effect device when running a sense current through the device to change the external magnetic field;

FIG. 3 is a cross-sectional view showing one example of the layer configuration according to a preferable aspect of the magnetoresistance effect device of the present invention;

FIG. 4 is a composition diagram showing the region of CoFeAl composition used for a free ferromagnetic layer of the present invention;

FIG. 5 is a composition diagram showing the region of CoMnAl composition used for a free ferromagnetic layer of the present invention;

FIG. 6 is a cross-sectional view showing an example of the structure of a tunnel type magnetoresistance effect device comprised of the magnetoresistance effect device of FIG. 3 with the nonmagnetic metal intermediate layer replaced by a nonmagnetic insulating layer;

FIG. 7 is a cross-sectional view showing an example of the structure of a dual-type magnetoresistance effect device comprised of two layers of the magnetoresistance effect device of FIG. 3;

FIG. 8 is a cross-sectional view showing an example of the structure of a magnetic head provided with a read head including the magnetoresistance effect device of the present invention;

FIG. 9 is a plan view showing an example of a magnetic recording system provided with a magnetic head using the magnetoresistance effect device of the present invention for the read head;

FIG. 10 is a perspective view schematically showing a current magnetic field type random access memory using the magnetoresistance effect device of the present invention; and

FIG. 11 is a perspective view schematically showing a spin injection type random access memory using the magnetoresistance effect device of the present invention.

### DESCRIPTION OF THE PREFERRED EMBODIMENT

Preferred embodiments of the present invention will be described in detail below while referring to the attached figures.

### Embodiment 1

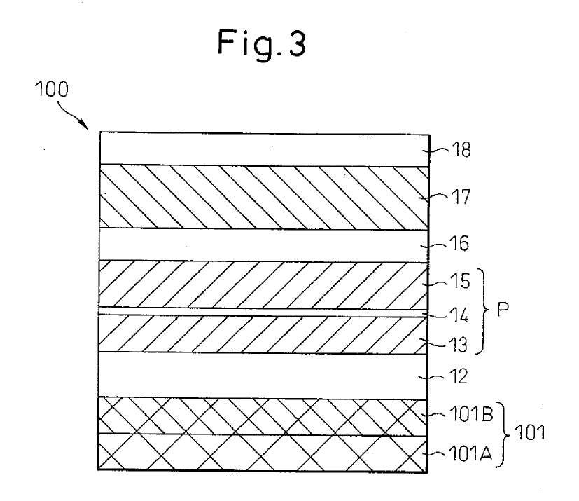

Referring to FIG. 3, a preferable embodiment of the magnetoresistance effect device of the present invention will be explained.

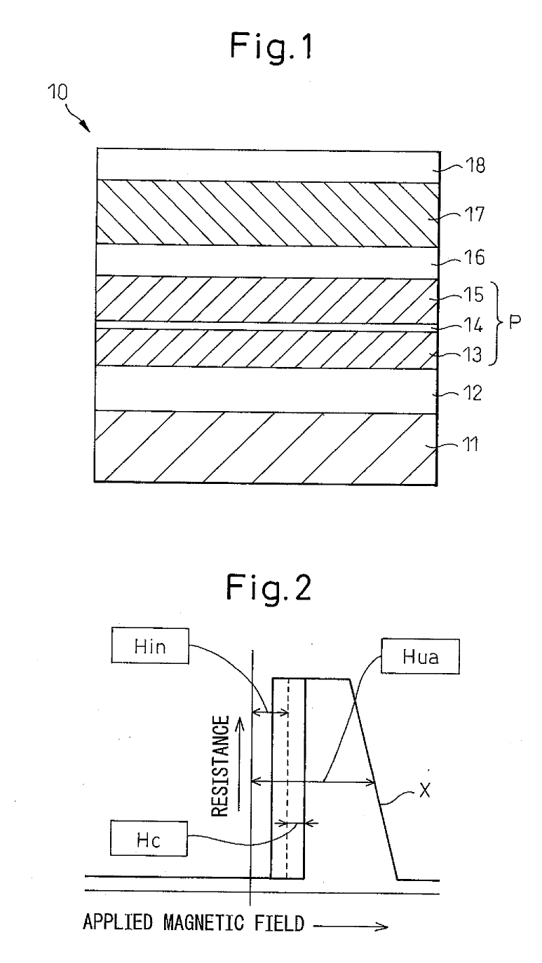

The magnetoresistance effect device 100 of the present invention 100 differs from the conventional magnetoresistance effect device 10 shown in FIG. 1 on only the point of changing the buffer layer 11 to a two-layer structure buffer layer 101. The rest of the layer configuration is the same. That is, the magnetoresistance effect device 100 of the present invention has a so-called synthetic ferri-pinned type spin valve film structure comprised of, in order from the bottom, a buffer layer 101, antiferromagnetic layer 12, first pinned ferromagnetic layer 13, nonmagnetic coupling layer 14, second pinned ferromagnetic layer 15, nonmagnetic metal intermediate layer 16, free ferromagnetic layer 17, and cap layer 18, the first pinned ferromagnetic layer 13/nonmagnetic coupling layer 14/second pinned ferromagnetic layer 15 forming a synthetic ferri pinned structure P.

Below, the components and requirements of the present invention will be explained.

Buffer Layer

The buffer layer 101 forming the characteristic feature of the present invention is comprised of a bottom layer of an amorphous metal buffer layer 101A and a top layer of a nonmagnetic metal buffer layer 101B and preferably has the following configuration:

The amorphous metal forming the bottom layer 101A of the buffer layer is preferably one of the following (a), (b), and (c):

(a) one type of single metal of Ta, Ti, and Zr,

(b) an amorphous alloy comprised of at least one type of ingredient of Fe, Co, Ni, and Cu and at least one type of ingredient of P, C, B, Si, Al, Ge, Be, Sn, In, Mo, W, Ti, Mn, Cr, Zr, Hf, and Nb, and

(c) an amorphous alloy of at least one type of ingredient of Ca, Mg, and Al and at least one of Zn and Cd.

These can be easily formed as amorphous film on a Cu/NiFe or other bottom electrode by room temperature sputtering or another low temperature film-forming method and block the effects of the crystal structure of NiFe etc. of the bottom electrode.

The nonmagnetic metal forming the top layer 101B of the buffer layer is preferably one type of metal selected from Ru, Cu, Au, Ag, Rh, Ir, Pt, Pd, Os, Al, W, Nb, Mo, Tc, Ti, V, and Cr.

These can be easily formed as a good crystal film on the amorphous metal buffer layer by room temperature sputtering or another low temperature film-forming method and increase the crystallinity of the synthetic ferri-pinned type spin valve structure formed on top.

Composition of Free Ferromagnetic Layer

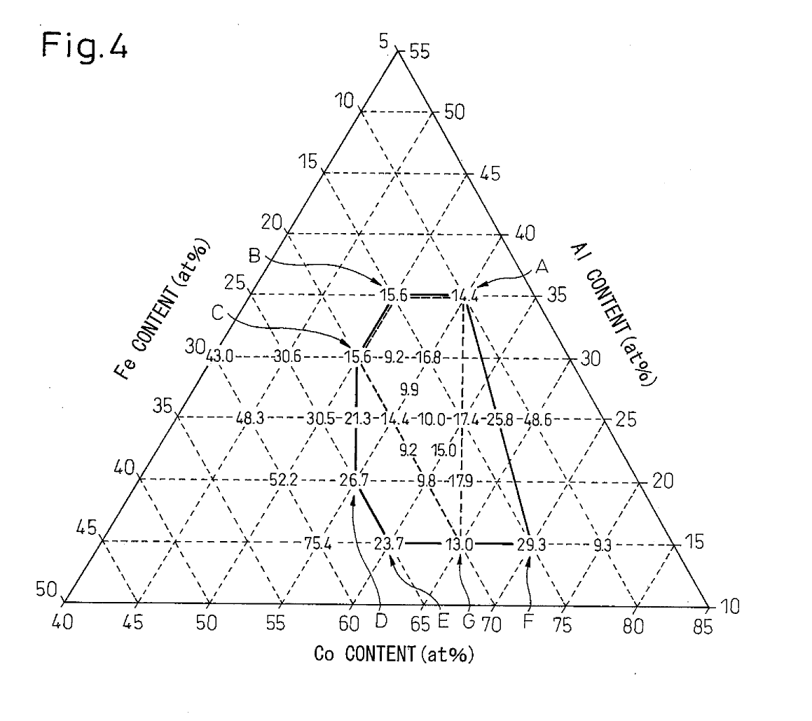

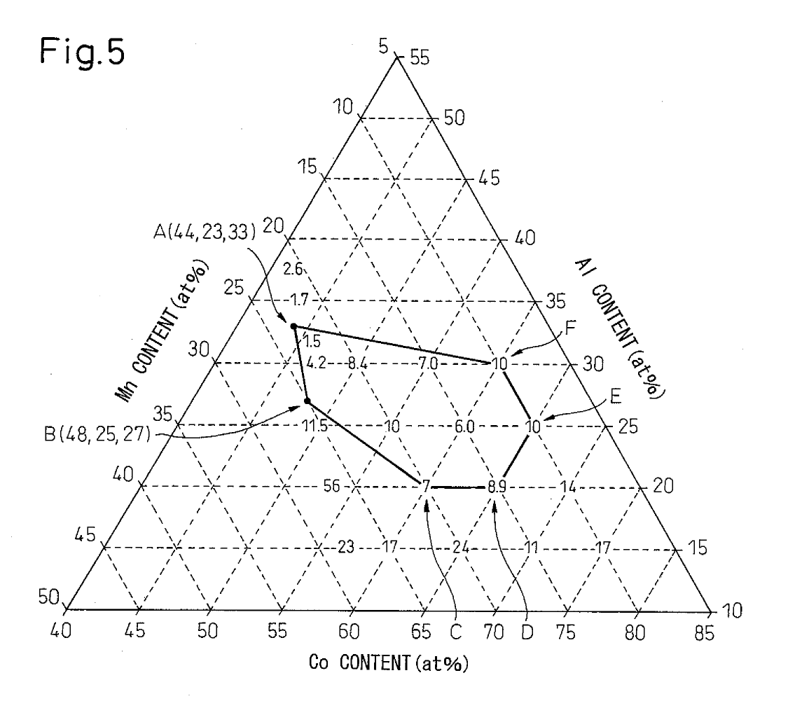

FIG. 4 and FIG. 5 show the (1) region of the CoFeAl composition and (2) region of the CoMnAl composition used for the free ferromagnetic layer of the present invention. As explained above, the assignee has already disclosed these in Japanese Patent Application No. 2005-244507 and Japanese Patent Application No. 2005-346065. The numerical values in the figures show the values of the coercivity Hc due to the compositions at different positions.

(1) Range of Composition of CoFeAl

In the composition diagram of FIG. 4, when expressing the coordinates of compositions as (Co content, Fe content, Al content [all of the units being atm %]), the CoFeAl composition used in the present invention is made a composition in the region ABCDEFA obtained by connecting a point A, point B, point C, point D, point E, point F, and point A in that order by straight lines for a point A (55,10,35), point B (50,15,35), point C (50,20,30), point D (55,25,20), point E (60,25,15), and point F (70,15,15). By using this range of composition, the free magnetization layer can be reduced in coercivity to 30 Oe or less. Due to this, the free magnetization layer has a coercivity lower than the coercivity 30.5 Oe of a Heusler alloy composition CO₅₀Fe₂₅Al₂₅ (see FIG. 4) and has a high sensitivity with respect to the signal magnetic field.

Note that even if the Al content is less than 15 atm % in range, the coercivity becomes 30 Oe or less, but according to studies of the inventors etc., ΔRA becomes 1 mΩμm² or so and the output ends up falling. Further, even if the Al content is larger than 35 atm % in range, the coercivity becomes 30 Oe, but the saturated magnetic moment tends to fall. To secure the desired product of the saturated magnetic moment and film thickness of the free magnetization layer, the free magnetization layer tends to increase in film thickness and as a result the read gap length increases and the output at a high recording density ends up falling.

Further, the preferable range of composition of the CoFeAl of the free magnetization layer lies in the range of the region ABCGA obtained by connecting a point A, point B, point C, point G, and point A in that order for a point A (55,10,35), point B (50,15,35), point C (50,20,30), point G (65,20,15). By making it within this range of composition, it is possible to further reduce the coercivity to 20 Oe or less. The composition in the region ABCGA is further lower in coercivity than the composition in the region ABCDEFA, so the magnetoresistance effect device is further improved in sensitivity.

Note that the value of the coercivity Hc shown in FIG. 4 is obtained by measurement of a dual spin valve film of the following layer configuration using a conventional NiCr buffer layer:

Buffer layer: NiCr (4 nm)

Bottom antiferromagnetic layer: IrMn (5 nm)

Bottom first pinned ferromagnetic layer: Co₆₀Fe₄₀ (3.5 nm)

Bottom nonmagnetic coupling layer: Ru (0.72 nm)

Bottom second pinned ferromagnetic layer: CoFeAl (5.0 nm)

Bottom nonmagnetic metal intermediate layer: Cu (3.5 nm)

Free ferromagnetic layer: CoFeAl (6.5 nm)

Top nonmagnetic metal intermediate layer: Cu (3.5 nm)

Top second pinned ferromagnetic layer: CoFeAl (5.0 nm)

Top nonmagnetic coupling layer: Ru (0.72 nm)

Top first pinned ferromagnetic layer: Co₆₀Fe₄₀ (3.5 nm)

Top antiferromagnetic layer: IrMn (5 nm)

Protective layer: Ru (5 nm)

As explained above, a CoFeAl composition is partially used as the pinned ferromagnetic layer as well.

(2) Range of Composition of CoMnAl

In the composition diagram of FIG. 5, if expressing the coordinates of the compositions as (Co content, Mn content, Al content [all of the units being atm %]), the composition of the CoMnAl used in the present invention becomes a composition in the region ABCDEFA obtained by connecting a point A, point B, point C, point D, point E, point F, and point A in that order for a point A (44,23,33), point B (48,25,27), point C (60,20,20), point D (65,15,20), point E (65,10,25), point F(60,10,30). By setting this range of composition, the free magnetization layer can be reduced in coercivity to the coercivity 11.5 Oe (see FIG. 5) of a Heusler alloy composition Co₅₀Mn₂₅Al₂₅ or less, and a high sensitivity to the signal magnetic field is obtained.

The range of composition of the free magnetization layer is preferably not one where the Al content is smaller than 20 atm % since the coercivity tends to increase. Further, in a composition where the Al content is higher than the side AF, the coercivity becomes low, but the drop in the saturated magnetic moment due to the increase in the nonmagnetic element Al is remarkable. The free magnetization layer has to have a product of its saturated magnetic moment and film thickness of a predetermined value or more, so with a composition where the Al content is greater than the side AF, the film thickness becomes greater and the so-called read gap length excessively increases. This is not preferable.

Note that the value of the coercivity Hc shown in FIG. 5 is obtained by measurement of a dual spin valve film of the following layer configuration using a conventional NiCr buffer layer.

Buffer layer: NiCr (4 nm)

Bottom antiferromagnetic layer: IrMn (5 nm)

Bottom first pinned ferromagnetic layer: Co₆₀Fe₄₀ (3.5 nm)

Bottom nonmagnetic coupling layer: Ru (0.7 nm)

Bottom interface magnetic layer: CoFe (0.5 nm)

Bottom second pinned ferromagnetic layer: Co_{100-X-Y}Mn_{X}Al_{Y}

Bottom second diffusion prevention layer: CoFe (0.5 nm)

Bottom nonmagnetic metal intermediate layer: Cu (3.5 nm)

Bottom first diffusion prevention layer: CoFe (0.5 nm)

Free ferromagnetic layer: Co_{100-X-Y}Mn_{X}Al_{Y}

Top first diffusion prevention layer: CoFe (0.5 nm)

Top nonmagnetic metal intermediate layer: Cu (3.5 nm)

Top second diffusion prevention layer: CoFe (0.5 nm)

Top second pinned ferromagnetic layer: Co_{100-X-Y}Mn_{X}Al_{Y}

Top nonmagnetic coupling layer: Ru (0.7 nm)

Top first pinned ferromagnetic layer: Co₆₀Fe₄₀ (3.5 nm)

Top antiferromagnetic layer: IrMn (5 nm)

Protective layer: Ru (5 nm)

As explained above, a CoMnAl composition is used as the second pinned ferromagnetic layer as well. Further, to prevent the diffusion of Mn from the free ferromagnetic layer and second pinned ferromagnetic layer to the nonmagnetic metal intermediate layer, different diffusion prevention layers are interposed. If Mn diffuses to the nonmagnetic metal intermediate layer, the second pinned ferromagnetic layer magnetization layer and the free magnetization layer have the same magnetization direction and end up magnetically exchange coupling, so end up moving by the same angle with respect to an external magnetic field leading to deterioration of the ΔRA. Further, to increase the magnetoresistance change ΔRA, a CoFe interface magnetic layer with spin dependent scattering larger than CoMnAl is also provided.

Composition of Pinned Ferromagnetic Layer

The magnetoresistance effect device of the present invention preferably uses for its pinned ferromagnetic layer the CoFeAl of the composition (1) of free ferromagnetic layers.

Further, in the layer configuration of the buffer layer/antiferromagnetic layer/first pinned ferromagnetic layer/nonmagnetic coupling layer/second pinned ferromagnetic layer/nonmagnetic metal intermediate layer (or nonmagnetic insulating intermediate layer)/free ferromagnetic layer/protective layer, as the composition of the second pinned ferromagnetic layer, CoMnZ, where Z is at least one type of Al, Si, Ga, Ge, Cu, Mg, V, Cr, In, Sn, B, and Ni, may be used.

Other Component Layers

Antiferromagnetic Layer

In FIG. 3, the antiferromagnetic layer 12 formed on the buffer layer 101 is for example a 4 nm to 30 nm (preferably 4 nm to 10 nm) thick Mn-TM alloy (TM including at least one type of metal from Pt, Pd, Ni, Ir, and Rh). As the Mn-TM alloy, for example, PtMn, PdMn, NiMn, IrMn, and PtPdMn may be mentioned. The antiferromagnetic layer 12 interacts with the first pinned ferromagnetic layer 13 of the synthetic ferri-pinned structure P to the magnetization of the first pinned ferromagnetic layer 13 to a predetermined direction.

Nonmagnetic Coupling Layer

In FIG. 3, the nonmagnetic coupling layer 14 is set in film thickness to a range where the first pinned ferromagnetic layer 13 and second pinned ferromagnetic layer 15 antiferromagnetically exchange couple. This range is 0.4 nm to 1.5 nm (preferably 0.4 nm to 0.9 nm). The nonmagnetic coupling layer 14 is comprised of Ru, Rh, Ir, a Ru-based alloy, Rh-based alloy, Ir-based alloy, or other nonmagnetic material. As the Ru-based alloy, a nonmagnetic material comprised of Ru plus one of Co, Cr, Fe, Ni, and Mn or an alloy of the sakme is preferable.

Nonmagnetic Metal Intermediate Layer

In FIG. 3, the nonmagnetic metal intermediate layer 16 is for example comprised of a 1.5 nm to 10 nm thick nonmagnetic conductive material. As the conductive material suitable for the nonmagnetic metal intermediate layer 16, Cu, Al, etc. may be mentioned.

### Embodiment 2

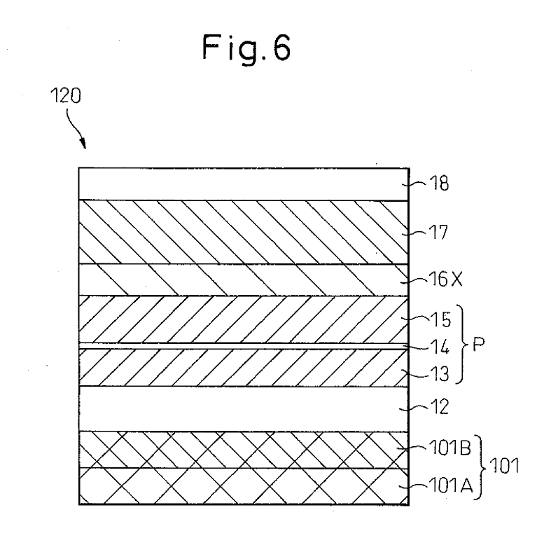

FIG. 6 shows an example of the structure of a tunnel type magnetoresistance effect device 120 comprised of the magnetoresistance effect device 100 of FIG. 3 with the nonmagnetic metal intermediate layer 16 replaced with the nonmagnetic insulating intermediate layer 16X. The rest of the layer configuration is the same as the layer configuration of the magnetoresistance effect device 100 shown in FIG. 3.

The nonmagnetic insulating intermediate layer 16X, for example, has a thickness of 0.2 nm to 2.0 nm and is comprised of at least one type of oxide selected from the group of Mg, Al, Ti, and Zr. As such oxides, MgO, AlOx, TiOx, ZrOx, VOx, LSMO (LaSrMnO₃), SFMO (Sr₂FeMoO₆), etc. may be mentioned. Here, x indicates compositions different from compositions of the compositions of the compounds of the materials may also be used. In particular, the nonmagnetic insulating intermediate layer 16X is preferably the crystalline MgO. In particular, in the sense of the increase in the amount of tunnel resistance change per unit area of the film surface perpendicular to the direction of the sense current, the (001) plane of the MgO is preferably substantially parallel to the film surface. Further, the nonmagnetic insulating intermediate layer 16X may also be comprised of a nitride or oxynitride of one type of element selected from the group of Al, Ti, and Zr. As such nitrides, AlN, TiN, and ZrN may be mentioned.

As the method of forming the nonmagnetic insulating intermediate layer 16X, the sputtering method, CVD method, or vapor deposition method may be used to directly form the material or the sputtering method, CVD method, or vapor deposition method may be used to form a metal film which is then oxidized or nitrided to convert it to an oxide film or nitride film.

### Embodiment 3

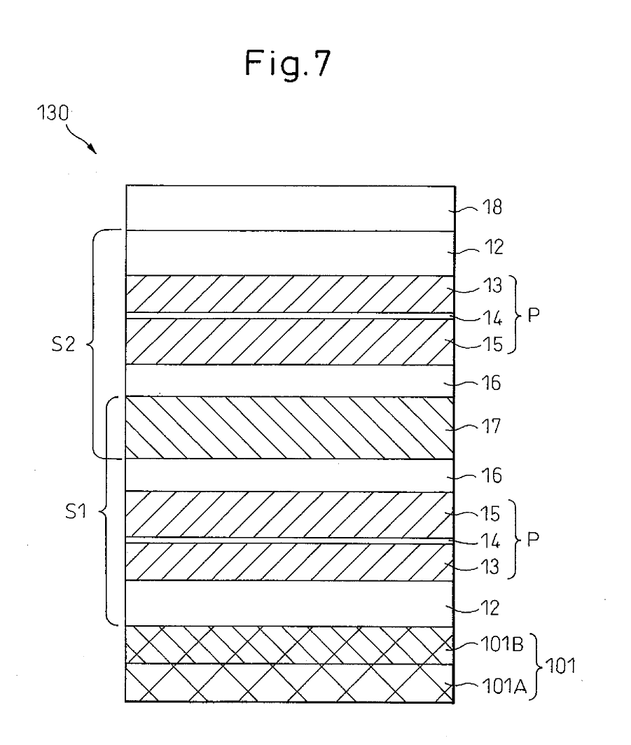

FIG. 7 shows an example of the structure of a dual-type magnetoresistance effect device comprised of two of the of the magnetoresistance effect devices 100 of FIG. 3.

The illustrated dual-type magnetoresistance effect device 130 has a dual-type synthetic ferri-pinned type spin valve structure comprised of a buffer layer 101 comprised of an amorphous metal buffer layer 101A and a nonmagnetic metal buffer layer 101B, a bottom synthetic region S1 where, among the component layers of the synthetic ferri-pinned type spin valve structure, the antiferromagnetic layer 12 through the first pinned ferromagnetic layer 13, nonmagnetic coupling layer 14, second pinned ferromagnetic layer 15, and nonmagnetic metal intermediate layer 16 to the free ferromagnetic layer 17 are stacked in that order from the bottom, and, above that, a top laminated region S2 comprised of the free ferromagnetic layer 17 through the nonmagnetic metal intermediate layer 16, second pinned ferromagnetic layer 15, nonmagnetic coupling layer 14, and first pinned ferromagnetic layer 13 to the antiferromagnetic layer 12 stacked in order from the bottom in the reverse order from the above, the two laminated regions S1, S2 being joined together sharing the free ferromagnetic layer 17. By adopting this dual-type, the output ΔRA can be doubled.

### Embodiment 4

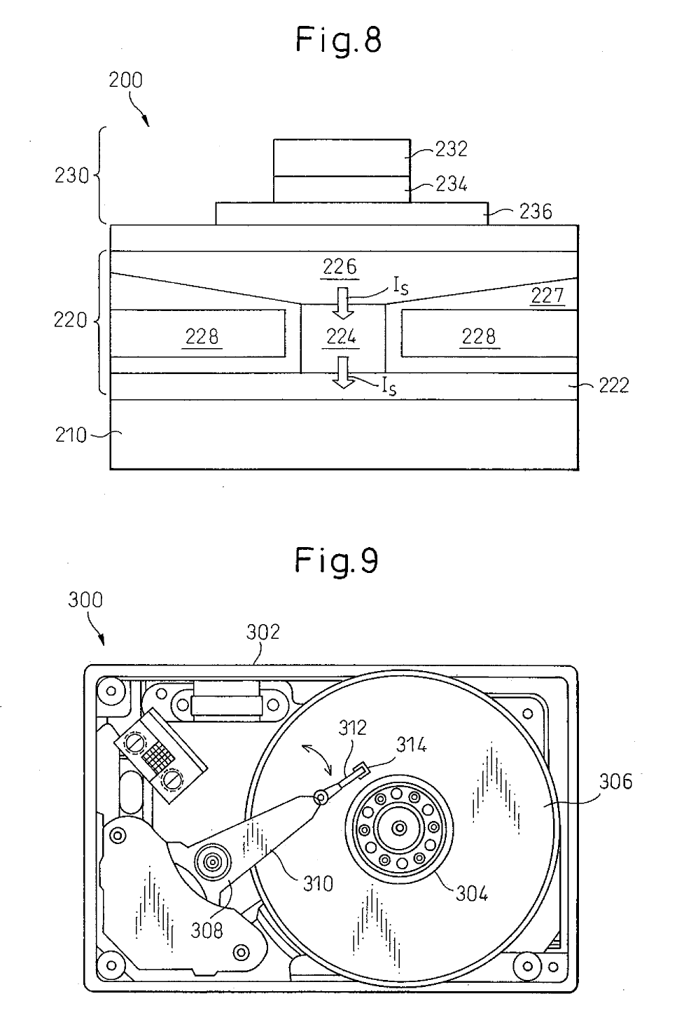

FIG. 8 shows an example of the structure of a magnetic head provided with a read head including the magnetoresistance effect device of the present invention.

The illustrated magnetic head 200 is comprised of a read head 220 including the magnetoresistance effect device of the present invention 224 (=100, 120, 130, etc.) formed on an AlTiC board 210 and a write head 230 comprised of an induction type recording device formed above it.

The write head 230 is comprised of a top magnetic pole 232 having a width corresponding to the track width of the magnetic recording medium at the surface facing the medium, a bottom magnetic pole 236 facing the top magnetic pole 232 across a recording gap layer 234 comprised of a nonmagnetic material, a yoke (not shown) magnetically connecting the top magnetic pole 232 and the bottom magnetic pole 236, and a coil (not shown) wound around the yoke and inducing a recording magnetic field by a recording current. The top magnetic pole 232, bottom magnetic pole 236, and yoke are comprised of a soft magnetic material. As this soft magnetic material, for securing the recording magnetic field, a material with a large saturated magnetic moment such as Ni₈₀Fe₂₀, CoZrNb, FeN, FeSiN, FeCo, CoNiFe, etc. may be mentioned. Note that the write head 230 is not limited to this. It is also possible to use a known structure of an induction type recording device.

The read head 220 provides a magnetoresistance effect device 224 (=100, 120, 130, etc.) on an AlTiC board 210 through a bottom electrode layer 222. A top electrode layer 226 is formed on top of the magnetoresistance effect device 224. The magnetoresistance effect device 224 is surrounded by a magnetic domain control layer 228 buried in an alumina or other insulating layer 227. A magnetic domain control film 228 is for example comprised of a laminate of a Cr film and a ferromagnetic CoCrPt film. The magnetic domain control film 228 makes the free magnetization layer forming the magnetoresistance effect device 224 (reference numeral 17 in FIGS. 3, 6, and 7) a single domain and prevents Barkhausen noise.

The bottom electrode 222 and top electrode 226 function as paths for the sense current Is and also as magnetic shields. Therefore, the bottom electrode 222 and top electrode 226 are comprised of soft magnetic alloys such as NiFe, CoFe, etc. Further, the interface between the bottom electrode 222 and the magnetoresistance effect device 224 may be provided with an induction film such as a Cu film, Ta film, Ti film, etc.

In general, the read head 220 and the write head 230 are covered with an alumina film, hydrogenated carbon film, etc. for preventing corrosion etc.

The sense current Is, for example, flows from the top electrode 226 through the magnetoresistance effect device 224 substantially perpendicularly to the surfaces of the component layers and then reaches the bottom electrode 222. The magnetoresistance effect device 224 changes in electrical resistance value in accordance with the strength and direction of the signal magnetic field leaking from the magnetic recording medium, that is, changes in magnetoresistance value. The magnetoresistance effect device 20 detects a change in the magnetoresistance value of the GMR film 30 as a voltage change by running a predetermined amount of sense current Is through it. In this way, the read head 220 including the magnetoresistance effect device 224 reproduces information recorded on the magnetic recording medium. Note that the direction of flow of the sense current Is is not limited to the direction shown in FIG. 1 and may also be an opposite direction.

### Embodiment 5

FIG. 9 is a plan view of a magnetic recording system provided with a magnetic head using the magnetoresistance effect device of the present invention for a reproduction head.

The illustrated magnetic recording system 300 is provided with a housing 302 inside which a hub 304 driven by a spindle (not shown), a magnetic recording medium 306 fixed to the hub 304 and rotated by a spindle, an actuator unit 308, an arm 310 supported by the actuator unit 308 and driven in a radial direction of the magnetic recording medium 306, a suspension 312, and a magnetic head 314 supported by the suspension 312 are provided.

The magnetic recording medium 306 may be a magnetic recording medium of either an in-plane magnetic recording system or perpendicular magnetic recording system or may be a recording medium having an inclined anisotropy. The magnetic recording medium 306 is not limited to a magnetic disk and may also be a magnetic tape.

The magnetic head 314 is for example the magnetic head 200 of FIG. 8, while the induction type recording device 230 may be a ring type recording device for in-plane recording or a single magnetic pole type recording device for perpendicular magnetic recording or another known recording device. The magnetoresistance effect device 220 is the magnetoresistance effect device of the present invention (=100, 120, 130, etc.), has a large magnetoresistance change ΔRA per unit area or large tunnel resistance change per unit area, and is high in output. Further, the free magnetization layer is reduced in coercivity, so the sensitivity is high. Accordingly, the magnetic recording system 300 is suitable for high recording density recording.

The CPP type magnetoresistance effect device of the present invention is also effective for application to magnetoresistive random access memories (MRAM). MRAMs, as explained below, are classified into current magnetic field types and spin injection types, but with either type, the characteristic features of the magnetoresistance effect device of the present invention of a high output (=able to be read and written with a lower current density) and low coercivity (=ease of magnetization inversion) are achieved, so a high density MRAM can be realized.

### Embodiment 6

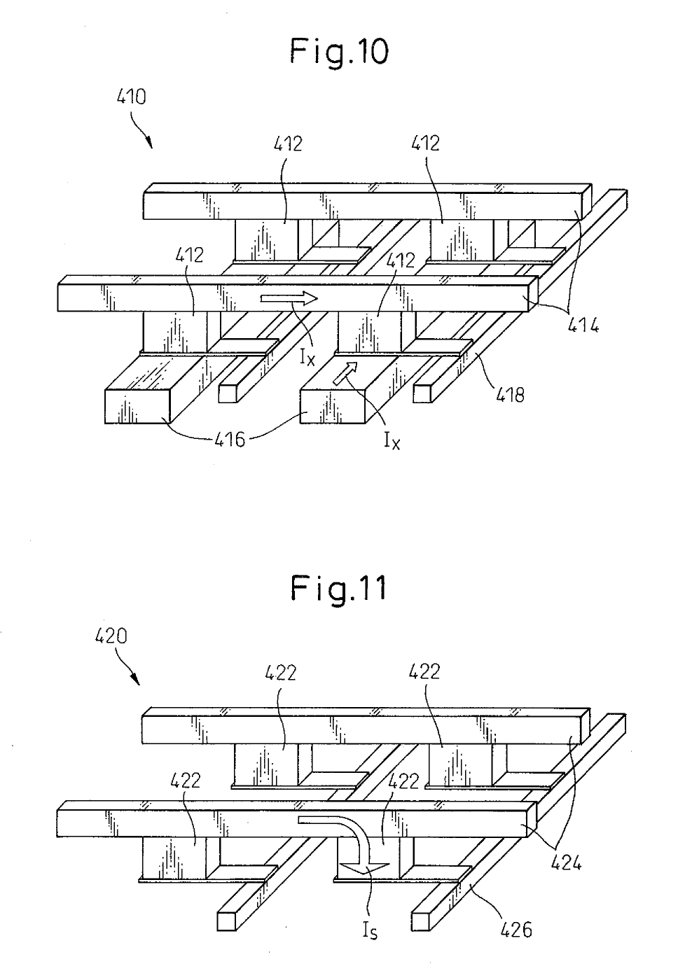

FIG. 10 schematically shows a current magnetic field type random access memory using the magnetoresistance effect device of the present invention.

The illustrated current magnetic field recording type MRAM 410 is comprised of a plurality of magnetoresistance effect devices 412 of the present invention (=100, 120, 130, etc.) arranged at lattice points of a matrix of a plurality of bit lines (lead lines) 414 and a plurality of word lines 416, which bit lines 414 and word lines 416 are connected to the top electrodes and bottom electrodes of the magnetoresistance effect devices 412.

In this structure, a current Ix is run through the bit lines 412 and word lines 416 to generate a current magnetic field which is used to cause magnetization inversion of the free ferromagnetic layers 17 (FIGS. 3, 6, 7) of the magnetoresistance effect devices 412. Reference numeral 418 shows an electrode for a read operation.

### Embodiment 7

FIG. 11 schematically shows a spin injection type random access memory using the magnetoresistance effect device of the present invention.

The illustrated spin injection type MRAM 420 uses a plurality of magnetoresistance effect devices 422 of the present invention and connects a plurality of bit lines (lead lines) 424 to the top electrodes of the magnetoresistance effect device 422.

In this structure, a spin polarized current Is is run through the bit line 424 to cause magnetization inversion of the free ferromagnetic layers 17 (FIGS. 3, 6, 7) of the magnetoresistance effect devices 422. Reference numeral 426 is an electrode for a read operation.

### EXAMPLES

### Example 1

Magnetoresistance effect devices according to the present invention were fabricated. For comparison, conventional examples and comparative examples of magnetoresistance effect devices were also fabricated. The invention examples, conventional examples, and comparative examples differed only in the layer configuration of the buffer layer. The rest of the layer configuration was the same.

Dual spin valve structure magnetoresistance effect devices shown in FIG. 7 were fabricated under the following conditions and by the following procedure.

In each case, a silicon substrate formed with a thermal oxide film was formed with a bottom electrode comprised of a laminated film of Cu (250 nm)/NiFe (50 nm) from the silicon substrate side.

Next, a sputtering system was used to form a buffer film 101 (FIG. 7) of the composition and thickness of Table 1 in a ultra high vacuum (vacuum degree of 2×10⁻⁶ Pa or less) at ordinary temperature (no heating of substrate etc.)

Next, the following layers were successively formed under the same conditions:

Antiferromagnetic layer 12: IrMn (5 nm)

Bottom first pinned ferromagnetic layer 13: CoFe (3.5 nm)

Nonmagnetic coupling layer 14: Ru (0.75 nm)

Bottom second pinned ferromagnetic layer 15: Co_{57.5}Fe₂₀Al_{22.5} or Co₄₅Mn_{22.5}Al_{32.5} (3.8 nm)

Nonmagnetic metal intermediate layer 16: Cu (3.5 nm)

Free ferromagnetic layer 17: Co_{57.5}Fe₂₀Al_{22.5} or Co₄₅Mn_{22.5}Al_{32.5} (3.8 nm)

Nonmagnetic metal intermediate layer 16: Cu (3.5 nm)

Top second pinned ferromagnetic layer 15: Co_{57.5}Fe₂₀Al_{22.5} or Co₄₅Mn_{22.5}Al_{32.5} (3.8 nm)

Nonmagnetic coupling layer 14: Ru (0.75 nm)

Top first pinned ferromagnetic layer 13: CoFe (3.5 nm)

Antiferromagnetic layer 12: IrMn (5 nm)

Protective layer 18: Ru (5 nm)

Next, the result was heat treated to bring out the antiferromagnetism of the antiferromagnetic layer 12. The heat treatment conditions were a heating time of 300° C., a treatment time of 3 hours, and an applied magnetic field of 1952 kA/m.

Next, the thus obtained laminate was ground by ion milling to prepare a laminate for forming devices of a size of 0.1 μm² to 0.6 μm² envisioning actual heads.

Finally, the obtained laminate was covered with a silicon oxide film, then dry etched to expose the protective layer. A top electrode made of Au film was formed so as to contact the protective layer and thereby obtain a magnetoresistance effect device.

Samples of the obtained devices were measured for magnetoresistance change (ΔRA), coercivity (Hc), magnetic field Hua of the point where the resistance is halved, and amount of shift Hin from a zero external magnetic field. The measurement conditions were as follows:

Measurement Conditions of Characteristics

Applied magnetic field: 1000 Oe

Sense current: 2 mA

Table 1 shows the measurement results all together.

TABLE 1

| | | Buffer layer | | | | |
|---|---|---|---|---|---|---|
| | | (numerals | | | | |
| Ferro- | | indicate | | | | |
| magnetic | | thickness | ΔRA | Hc | Hua | Hin |
| layer | Class | (nm)) | (mΩμm²) | (Oe) | (Oe) | (Oe) |
| Co—Fe—Al | Conv. | NiCr4 | 6.3 | 8.7 | 2028 | 8.4 |
| | ex. | | | | | |
| | Comp. | Ru4 | 6.8 | 0.5 | 1135 | 54.5 |
| | ex. | | | | | |
| | Inv. ex. | Ta4/Ru4 | 7.4 | 3.8 | 1612 | 11.4 |
| | Comp. | Ta4/NiFe4 | 6.6 | 6.5 | 1707 | 9.2 |
| | ex. | | | | | |
| Co—Mn—Al | Conv. | NiCr4 | 4.2 | 3.9 | 1767 | 8.4 |
| | ex. | | | | | |
| | Comp. | Ru4 | 4.8 | 1.4 | 975 | 82.1 |
| | ex. | | | | | |
| | Inv. ex. | Ta4/Ru4 | 5.0 | 0.4 | 1475 | 10.2 |
| | Comp. | Ta2/NiCr4 | 3.3 | 1.2 | 1618 | 11.3 |
| | ex. | | | | | |
| | Comp. | NiCr4/Ta1/ | 2.7 | 0.3 | 1348 | 14.7 |
| | ex. | Cu1 | | | | |

Comparing the NiCr layer and single Ru layer of the conventional buffer layers, both when using a CoFeAl and CoMnAl ferromagnetic layer, the ΔRA and the Hc are improved, but the Hua drops to half and the Hin sharply increases to 50 Oe or more.

As opposed to this, if applying the two-layer structure of the amorphous metal buffer layer/nonmagnetic metal buffer layer of the present invention to obtain a two-layer buffer layer of Ta (4 nm)/Ru (4 nm), compared with the conventional NiCr buffer layer, the Hin remains the same and the Hua drops to ¾, but the Hc falls to half in the case of a CoFeAl ferromagnetic layer and falls to substantially zero in the case of a CoMnAl ferromagnetic layer. Further, the output ΔRA increases about 20% when using either ferromagnetic layer.

Here, the comparative examples using other combinations besides the Ta/Ru2 layer structure (Ta/NiFe, Ta/NiCr, NiCr/Ta/Cu) were only slightly superior to the conventional example of a NiCr buffer layer particularly in the ΔRA. The Hua can be increased by the ratio of the magnetic moments of the first pinned ferromagnetic layer and second pinned ferromagnetic layer, but it is generally difficult to reduce the Hc and Hin. The Hua falling to about ¾ is not that great a problem compared with the Hc falling to half. Due to this, the two-layer buffer layers of combinations of Ta/Ru according to the present invention are greatly increased in ΔRA and remarkably reduced in Hc compared with the conventional buffer layer NiCr. Simultaneously, a large Hua of 1400 or more and a small Hin of 20 Oe or less can be secured.

### Example 2

In the CPP structure, the thickness of the cap layer from the buffer layer becomes the read gap as it is, so it is necessary to make the thickness of the buffer layer as thin as possible for high recording density reading.

The thickness of the Ta of the amorphous metal buffer layer and the thickness of the Ru of the nonmagnetic metal buffer layer in the combination of the CoFeAl ferromagnetic layer and the Ta/Ru two-layer buffer layer of Example 1 were changed in various ways to prepare magnetoresistance effect devices which were then evaluated for characteristics. The method of preparation and the method of evaluation were similar to those in Example 1. The evaluation results are summarized in Table 2.

TABLE 2

| | Buffer layer | | | | |
|---|---|---|---|---|---|
| | (numerals | | | | |
| Ferro- | indicate | | | | |
| magnetic | thickness | ΔRA | | | |
| layer | (nm)) | (mΩμm²) | Hc (Oe) | Hua (Oe) | Hin (Oe) |
| Co—Fe—Al | Ta3/Ru4 | 7.3 | 2.3 | 1673 | 12.8 |
| | Ta2/Ru4 | 7.1 | 2.7 | 1673 | 13.3 |
| | Ta1/Ru4 | 7.0 | 1.8 | 1632 | 13.9 |
| | Ta4/Ru4 | 7.3 | 2.9 | 1666 | 12.4 |
| | Ta4/Ru2 | 7.1 | 2.2 | 1612 | 13.4 |
| | Ta4/Ru1 | 7.3 | 2.2 | 1632 | 12.9 |
| | Ta1/Ru3 | 6.9 | 1.2 | 1632 | 17.7 |
| | Ta1/Ru2 | 7.9 | 1.4 | 1537 | 19.0 |
| | Ta1/Ru1 | 7.1 | 1.5 | 1585 | 16.3 |
| | Ta0.5/Ru4 | 6.7 | 0.2 | 1166 | 61.2 |

The Ta layers and Ru layers were reduced in thickness from 4 nm. If making the Ta layer a thickness of 0.5 nm, the increase in Hin cannot be suppressed, but if the Ta layer has a thickness of 1 nm, a sufficient effect of reduction of the Hin can be obtained. On the other hand, the ΔRA, Hc, Hua, and Hin do not change much at all even if reducing the thickness of the Ta layer to 1 nm. Even with Ta 1 nm/Ru 1 nm (buffer layer thickness: 2 nm), a high ΔRA (≧6.3 mΩμm²) and Hua (≧1400 Oe) and a low Hc (≦3 Oe) and Hin (≦20 Oe) are achieved and a sufficient function as a buffer layer is realized.

This shows that while a conventional NiCr buffer layer had to be 4 nm or more, the thickness can be reduced to half. From the viewpoint of the reduction of the read gap as well, the buffer layer of the present invention is extremely advantageous.

In the above examples, giant magnetoresistance (GMR) devices using nonmagnetic metal intermediate layers 16 were explained, but a tunnel magnetoresistance effect device TMR where the nonmagnetic metal intermediate layer 16 is replaced with a nonmagnetic insulating intermediate layer 16X also gives similar effects. As the nonmagnetic insulating intermediate layer 16X, as already explained, MgO, AlOx, TiOx, ZrOx, VOx, LSMO (LaSrMnO₃), SFMO (Sr₂FeMoO₆), etc. may be mentioned.

While the invention has been described with reference to specific embodiments chosen for purpose of illustration, it should be apparent that numerous modifications could be made thereto by those skilled in the art without departing from the basic concept and scope of the invention.

1. A magnetoresistance effect device having a spin valve structure including a buffer layer at a bottommost layer, a pinned ferromagnetic layer above that, a nonmagnetic metal intermediate layer, and a free ferromagnetic layer, wherein said free ferromagnetic layer is comprised of one of the following (1) and (2):
(1) a composition in the region of a CoFeAl ternary system composition diagram obtained by connecting a point A, point B, point C, point D, point E, point F, and point A by straight lines in that order for a point A (55,10,35), point B (50,15,35), point C (50,20,30), point D (55,25,20), point E (60,25,15), and point F (70,15,15) when expressing the coordinates of compositions as (Co content, Fe content, Al content [unit of each content being atm %]) and
(2) a composition in the region of a CoMnAl ternary system composition diagram obtained by connecting a point A, point B, point C, point D, point E, point F, and point A by straight lines in that order for a point A (44,23,33), point B (48,25,27), point C (60,20,20), point D (65,15,20), point E (65,10,25), and point F (60,10,30) when expressing the coordinates of the compositions as (Co content, Mn content, Al content [unit of each content being atm %]),
said buffer layer being comprised of a bottom layer of an amorphous metal buffer layer and a top layer of a nonmagnetic metal buffer layer.

2. A magnetoresistance effect device as set fort in claim 1, wherein
said amorphous metal buffer layer is comprised of one of the following (a), (b), and (c):
(a) one single metal of Ta, Ti, and Zr,
(b) an amorphous alloy comprised of at least one ingredient of Fe, Co, Ni, and Cu and at least one ingredient of P, C, B, Si, Al, Ge, Be, Sn, In, Mo, W, Ti, Mn, Cr, Zr, Hf; and Nb, and
(c) an amorphous alloy comprised of at least one ingredient of Ca, Mg, and Al and at least one ingredient of Zn and Cd,
said nonmagnetic metal buffer layer comprising one of the following: Ru, Cu, Au, Ag, Rh, Ir, Pt, Pd, Os, Al, W, Nb, Mo, Tc, Ti, V, and Cr.

3. A magnetoresistance effect device as set forth in claim 1, wherein said pinned ferromagnetic layer is comprised of the composition of the above (1).

4. A magnetoresistance effect device as set forth in claim 1, wherein said spin valve structure is a so-called synthetic ferri-pinned structure comprised of, in order from the bottom, said buffer layer, antiferromagnetic layer, first pinned ferromagnetic layer, nonmagnetic coupling layer, second pinned ferromagnetic layer, nonmagnetic metal intermediate layer, free ferromagnetic layer, and protective layer.

5. A magnetoresistance effect device as set forth in claim 4, wherein said second pinned ferromagnetic layer is comprised of CoMnZ, where Z is at least one element of Al, Si, Ga, Ge, Cu, Mg, V, Cr, In, Sn, B, and Ni.

6. A magnetoresistance effect device as set forth in claim 4, wherein the device is a tunnel type replacing the nonmagnetic metal intermediate layer of said synthetic ferri-pinned spin valve structure with a nonmagnetic insulating intermediate layer.

7. A magnetoresistance effect device as set forth in claim 4, wherein the device has a dual-type synthetic ferri-pinned spin valve structure comprised of said buffer layer, a bottom laminated region where, among the component layers of said synthetic ferri-pinned spin valve structure, the antiferromagnetic layer to the free ferromagnetic layer are stacked in order from the bottom, and, on top of this, a top laminated region where the free ferromagnetic layer to the antiferromagnetic layer are stacked in order from the bottom in the reverse order from this, the two laminated regions being joined together sharing a free ferromagnetic layer.

8. A magnetoresistance effect device as set forth in claim 4 having a free ferromagnetic layer comprised of a CoMnAl composition of (2) or a CoMnZ composition, provided with a synthetic ferri-pinned spin valve structure, and provided between the free ferromagnetic layer and said nonmagnetic metal intermediate layer or nonmagnetic insulating intermediate layer with a diffusion prevention layer for preventing diffusion of Mn from the free ferromagnetic layer to said nonmagnetic metal intermediate layer or nonmagnetic insulating intermediate layer, said diffusion prevention layer comprised of one of the following (A) and (B):
(A) a ferromagnetic material comprised of at least one metal of Co, Fe, and Ni or their alloys and
(B) a nonmagnetic material comprised of at least one metal of Ti, Ta, W, Au, Pt, Mo, and Hf or their alloys.

9. A magnetoresistance effect device as set forth in claim 1, having a magnetoresistance change ΔRA ≧6.3 mΩμm², a coercivity Hc≦5 Oe, a magnetic field Hua of the point where the resistance becomes half ≧1400 Oe, and an amount of shift Hin from a zero external magnetic field ≦20 Oe.

10. A magnetoresistance effect device as set forth in claim 1, wherein said buffer layer has a thickness of the amorphous metal buffer layer of at least 1 nm and the nonmagnetic metal buffer layer of at least 1 nm.

11. A magnetic head provided with a read head including a magnetoresistance effect device as set forth in claim 1.

12. A magnetic recording system provided with a magnetic head as set forth in claim 11 and a magnetic recording medium.

13. A magnetic random access memory of a current magnetic field recording type provided with a structure using a plurality of magnetoresistance effect devices as set forth in claim 1, arranging them at lattice points of a matrix comprised of a plurality of bit lines and a plurality of word lines, and connecting the plurality of bit lines and the plurality of word lines to the top electrodes and bottom electrodes of the plurality of magnetoresistance effect devices, magnetization inversion of said free ferromagnetic layer being induced by a current magnetic field generated by running a current through said bit lines and said word lines.

14. A magnetic random access memory of a spin injection type provided with a structure using a plurality of magnetoresistance effect devices as set forth in claim 1 and connecting a plurality of bit lines to top electrodes of said plurality of magnetoresistance effect devices, magnetization inversion of said free ferromagnetic layer being induced by running a spin polarized current through said bit lines.
